(19) United States
(12) Patent Application Publication
(10) Pub. No.: US 2018/0374398 A1
(43) Pub. Date: Dec. 27, 2018

(54) CURVATURE-ADJUSTABLE CURVED DISPLAY APPARATUS

(71) Applicant: Chongqing HKC Optoelectronic Technology Co., Ltd., Chongqing (CN)

(72) Inventor: Chia-Hang LEE, Chongqing (CN)

(21) Appl. No.: 15/556,112

(22) PCT Filed: Apr. 28, 2017
(86) PCT No.: PCT/CN2017/082363

§ 371 Date: Jul. 10, 2018

(30) Foreign Application Priority Data
Dec. 31, 2016 (CN) 201611268271.0

(51) Int. Cl. G09F 9/30; H04N 21/41; H04N 21/442; G02F 1/1333

(52) U.S. Cl. CPC G09F 9/301; H04N 21/41; H04N 21/44218; G06F 2200/1612; G09G 2380/02; G09G 2354/00; G02F 1/133305

(57) ABSTRACT

This application relates to a curvature-adjustable curved display apparatus. The curved display apparatus includes: a curved display, an image sensor, and a processing unit. The curved display may allow to be bent by a display surface bending distance according to an optimal curvature, and the image sensor is disposed on the curved display to obtain scenario picture information. The processing unit is configured to calculate a location of a viewer in the scenario picture information, and calculate an angle between the viewer and a central line of the curved display by using the location, where the optimal curvature is calculated by using the angle.

### BACKGROUND

### Technical Field

This application relates to a curved display apparatus control method, and in particular, to a curvature-adjustable curved display apparatus.

### Related Art

Currently, more televisions are designed as curved televisions. This is mainly because curved televisions have a novel appearance. In addition, curved televisions have outstanding picture quality. In particular, when conventional flat-screen LCD (both VA LCD and IPS LCD) televisions are viewed, there is generally a color difference between a large viewing angle and a central viewing angle, and picture quality is poorer as a viewing angle becomes larger.

To improve a viewing angle of conventional flat-screen LCDs, one pixel is divided into two sub-pixels, that is, a sub-pixel A and a sub-pixel B, and a gamma curve of the sub-pixel A and the sub-pixel B is controlled by using a voltage, to offset and alleviate a color difference of a lateral viewing angle. This offset method is referred to as a spatial pixel offset method.

In addition, another method for improving picture quality of a viewing angle is to design a curved display. That is, a corresponding display curvature is calculated for a preset viewing distance. Generally, a display curvature is approximately R2000, and a television curvature is designed to be approximately R4000. When a proper curvature and a proper viewing distance are provided, various viewing angles of a display are consistent with a central front viewing angle of the display, to resolve the problem of picture quality degradation of a screen that is caused by different viewing angles.

Conventionally, curved displays are designed for a single viewer in an on-axis coordinate location (that is, a central location). However, generally, a television may not be viewed by only one viewer, and may not be viewed in a central location either. Therefore, despite a condition of an optimal viewing angle of a curved television, it is highly probable that optimal picture quality cannot be obtained because of different locations of viewers.

### SUMMARY

To resolve the foregoing technical problem, an objective of this application is to provide a curved display apparatus, and in particular, a curvature-adjustable curved display apparatus that can automatically adjust a curvature of a display surface of a display, to conform to optimal curvatures for one or more viewers at different locations.

An objective of this application is achieved and the technical problem of this application is resolved by using the following technical solutions. The curved display apparatus of this application may comprise a curved display, an image sensor, and a processing unit. The curved display may allow to be bent by a display surface bending distance according to an optimal curvature, and the image sensor is disposed on the curved display to obtain scenario picture information. The processing unit is configured to calculate a location of a viewer in the scenario picture information, and calculate an angle between the viewer and a central line of the curved display by using the location, where the optimal curvature is calculated by using the angle.

In some embodiments, the curved display of the curved display apparatus may be, for example, a liquid crystal display, an OLED display, a micro LED display, a laser display, a plasma display screen, or a flat-panel display of another type.

A control method for adjusting a curvature of a curved display provided in this application comprises: obtaining scenario picture information by using an image sensor installed on a curved display; calculating a location of a viewer in the scenario picture information by using a processing unit; calculating an angle between the viewer and a central line of the curved display by using the location; and calculating optimal viewing angle information by using the angle, and obtaining an optimal curvature by using the optimal viewing angle information, to control a display surface bending distance of the curved display.

Another objective of this application is to provide a curved television, comprising a control method for adjusting a curvature of a curved display. The method comprises: obtaining scenario picture information by using an image sensor installed on a curved display; calculating a location of a viewer in the scenario picture information by using a processing unit; calculating an angle between the viewer and a central line of the curved display by using the location; and calculating optimal viewing angle information by using the angle, and obtaining an optimal curvature by using the optimal viewing angle information, to control a display surface bending distance of the curved display.

Alternatively, an objective of this application may be achieved and the technical problem of this application may be resolved by using the following technical solutions.

In an embodiment of this application, the scenario picture information is used by the image sensor to obtain spatial information of the viewer.

In an embodiment of this application, there is a plurality of image sensors.

In an embodiment of this application, the image sensor comprises a pantoscopic lens.

In an embodiment of this application, the processing unit comprises a facial recognition system, configured to recognize a quantity of viewers in the scenario picture information.

In an embodiment of this application, the location is a distance between the viewer and a central line of the curved display, and a linear distance between the viewer and the curved display.

In an embodiment of this application, if the viewer is located on the left of the central line of the curved display, the distance between the viewer and the central line is X1, and the linear distance between the viewer and the curved display is D, the angle θL is arctan (−X1/D); or if the viewer is located on the right of the central line of the curved display, the distance between the viewer and the central line is X2, the linear distance between the viewer and the curved display is D, and the angle θR is arctan (X2/D), where the optimal viewing angle information is θeff=(θL+θR)/2.

In an embodiment of this application, the optimal viewing angle information is θeff=(θL+θR)/2 and may be equal to a formula

$${θ}_{eff} = \frac{1}{n} {\sum }_{k = 0}^{n} {θ}_{k} ,$$

where n is a quantity of viewers.

In an embodiment of this application, θeff is in a range of 0 degrees to 90 degrees, the optimal curvature is in a range of 4000R to a flat surface, and the display surface bending distance is in a range of 50 mm to 0 mm.

In this application, an image sensor apparatus and a processing unit perform analysis, and a method for intelligently and automatically controlling a display curvature is designed. This application is more flexible than conventional televisions with a fixed curvature, better conforms to an actual application scenario of a viewer, and greatly improves picture quality for a viewer at different viewing angles.

### BRIEF DESCRIPTION OF THE DRAWINGS

FIG. 1 is a flowchart of a control method for adjusting a curvature of a curved display according to an embodiment of this application;

FIG. 2 is a block diagram of a control method for adjusting a curvature of a curved display according to an embodiment of this application;

FIG. 3 is a schematic diagram of a control method for adjusting a curvature of a curved display according to an embodiment of this application;

FIG. 4 is a schematic diagram of an angle in a control method for adjusting a curvature of a curved display according to an embodiment of this application; and

FIG. 5 is a schematic diagram of a curvature-adjustable curved display apparatus according to an embodiment of this application.

### DETAILED DESCRIPTION

The following embodiments are described with reference to accompanying drawings, to provide examples of particular implementable embodiments of this application. Directional terms described in this application, for example, “above”, “below”, “front”, “back”, “left”, “right”, “internal”, “external”, and “lateral face” indicate only directions with reference to accompanying drawings. Therefore, the used directional terms are intended to describe and understand this application, instead of limiting this application.

Accompanying drawings and descriptions are considered as essentially illustrative instead of limitative. In the drawings, units having similar structures are indicated by a same reference number. In addition, for ease of understanding and description, the size and the thickness of each component shown in the accompanying drawings are randomly shown, but this application is not limited thereto.

In the accompanying drawings, for the purpose of clarity, thicknesses of layers, sheets, panels, regions, and the like are enlarged. In the accompanying drawings, for ease of understanding and description, thicknesses of some layers and regions are enlarged. It should be understood that, when it is described that components such as layers, films, regions, or substrates are located “on” another component, the component may be directly located on the another component, or there may be a component there-between.

In addition, in this specification, unless otherwise described clearly, the term “include” shall be understood as including a component, but not excluding any other components. In addition, in this specification, “on” means that a component is located above or below a target component, and does not mean that a component needs to be located on the top based on a gravity direction.

To further describe technical solutions used in this application to achieve a preset application objective and technical effects of this application, the following describes, with reference to the accompanying drawings and preferred embodiments, in detail specific implementations, structures, features, and effects of a curvature-adjustable curved display apparatus provided based on this application.

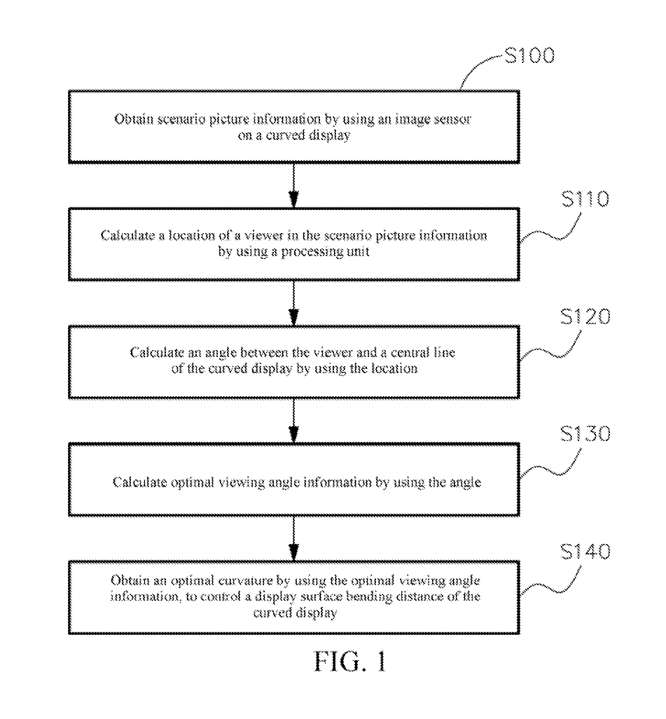

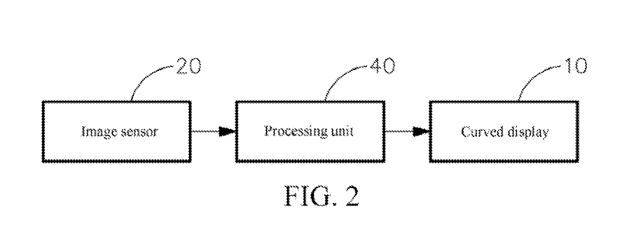

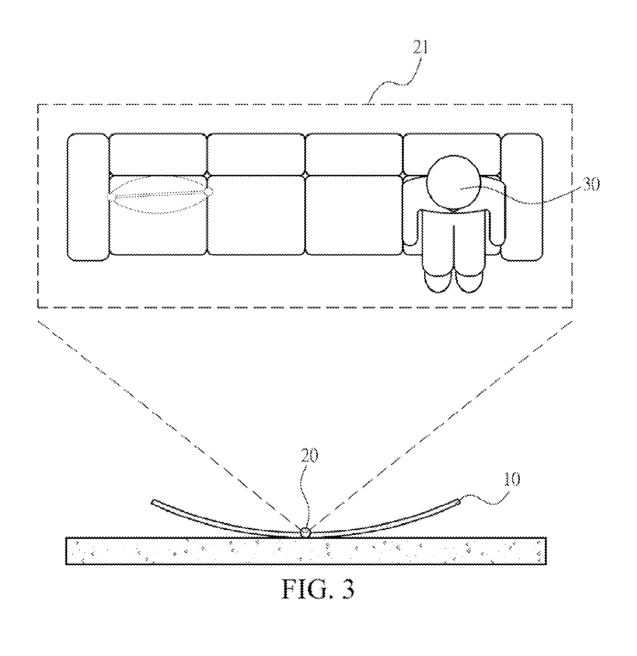

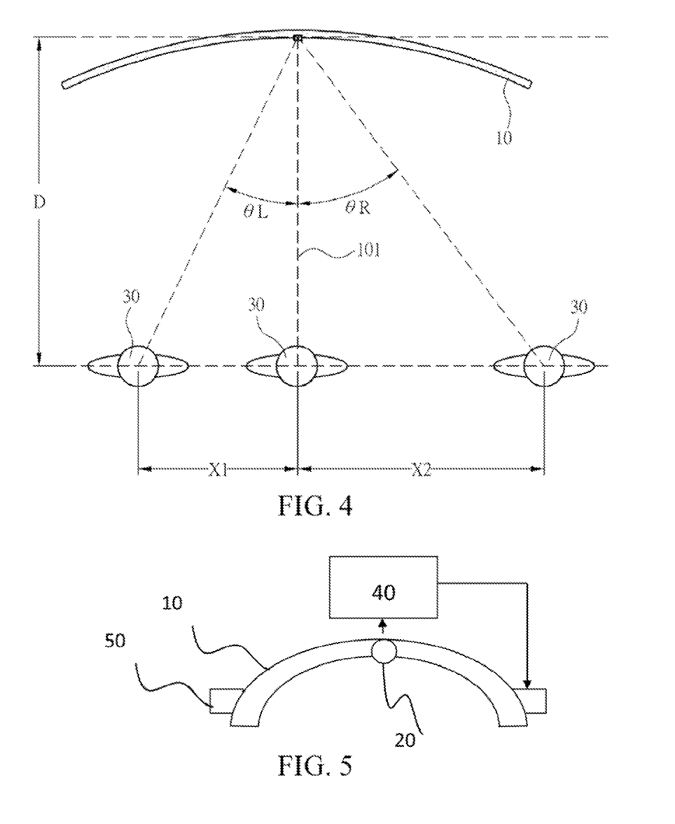

Referring to FIG. 1 to FIG. 4, FIG. 1 is a flowchart of a control method for adjusting a curvature of a curved display according to an embodiment of this application, FIG. 2 is a block diagram of a control method for adjusting a curvature of a curved display according to an embodiment of this application, FIG. 3 is a schematic diagram of a control method for adjusting a curvature of a curved display according to an embodiment of this application, and FIG. 4 is a schematic diagram of an angle in a control method for adjusting a curvature of a curved display according to an embodiment of this application.

The curved display apparatus of this application may include a curved display 10, an image sensor 20, and a processing unit 40. The curved display 10 may allow to be bent by a display surface bending distance according to an optimal curvature, and the image sensor 20 is disposed on the curved display 10 to obtain scenario picture information 21. The processing unit 40 is configured to calculate a location of a viewer 30 in the scenario picture information 21, and calculate an angle between the viewer and a central line of the curved display by using the location, where the optimal curvature is calculated by using the angle.

In some embodiments, the curved display 10 may be, for example, a liquid crystal display, an θLED display, an LED display, a laser display, a plasma display screen, or a flat-panel display of another type.

In the embodiments of this application, it should be understood that, a calculation apparatus and/or method may be variable, and does not need to operate completely according to the correlation described below, and any variation shall fall within the scope of the embodiments. It should be understood that, in some embodiments, the method of this application may be implemented by the processing unit 40, for example, by running an application program.

Exemplarily, the processing unit 40 may include a processor, a primary memory (for example, a read only memory (ROM), a flash memory, or a dynamic random access memory (DRAM) such as a synchronous DRAM (SDRAM) or a Rambus DRAM (RDRAM)), a static memory (for example, a flash memory or a static random access memory (SRAM)), and an auxiliary memory (for example, a data storage component). These devices communicate with each other by using a bus.

The processor of the processing unit 40 may be one or more general-purpose processing components such as a micro processor and a central processing unit. More specifically, the processor may be a complex instruction set computing (CISC) micro processor, a reduced instruction set computing (RISC) micro processor, a very long instruction word (VLIW) micro processor, a processor implementing another instruction set, or a processor implementing an instruction set combination. Alternatively, the processor may be one or more dedicated processing components such as an application specific integrated circuit (ASIC), a field programmable gate array (FPGA), a digital signal processor (DSP), or a network processor. The processor is configured to execute processing logic of the operations described in this specification.

It should be noted that, unless otherwise described, the control method for adjusting a curvature of a curved display in this application does not need to be performed according to the definite sequence shown in figures; and a plurality of similar procedures (blocks) may be performed concurrently instead of sequentially. Therefore, elements of the method of this application are referred to as “procedures (blocks)” instead of “steps” in this specification. It should also be understood that, the method of this application may also be implemented by making a variation to a calculation apparatus.

First referring to FIG. 1 and FIG. 3, a procedure of a control method for adjusting a curvature of a curved display in this application includes: a procedure S100 of obtaining scenario picture information 21 by using an image sensor 20 installed on a curved display 10. In an embodiment of this application, the scenario picture information 21 is used by the image sensor 20 to obtain spatial information of a viewer 30.

In an embodiment of this application, under the precondition that the scenario picture information 21 can be obtained, there may be a plurality of image sensors 20 that may be separately disposed on any locations of the curved display 10.

In an embodiment of this application, the image sensor 20 may include a pantoscopic lens under the precondition that the scenario picture information 21 can be obtained.

Next, referring to both FIG. 1 and FIG. 2, the method includes a procedure S110 of calculating a location of the viewer 30 in the scenario picture information 21 by using a processing unit 40. In an embodiment of this application, the processing unit 40 includes a facial recognition system, configured to recognize faces of viewers 30 in the scenario picture information 21 to determine a quantity of the viewers 30.

In an embodiment of this application, referring to FIG. 4, the location is distances X1 and X2 between the viewer 30 and a central line 101 of the curved display 10, and a linear distance D between the viewer 30 and the curved display 10, and the linear distance D is parallel with the central line 101.

Next, referring to both FIG. 1 and FIG. 4, the method includes a procedure S120 of calculating an angle between the viewer 30 and the central line 101 of the curved display 10 by using the location. With reference to the central line 101, if the viewer 30 is located on the left of the central line 101 of the curved display 10, the distance between the viewer 30 and the central line 101 is X1, and the linear distance between the viewer 30 and the curved display 10 is D, the angle θL is arctan (−X1/D). An angle of θL is in a range of 0 degrees to −90 degrees. If the viewer 30 is located on the right of the central line 101 of the curved display 10, the distance between the viewer 30 and the central line 101 is X2, and the linear distance between the viewer 30 and the curved display 10 is D, the angle θR is arctan (X2/D). An angle of θR is in a range of 0 degrees to 90 degrees.

Next, the method includes a procedure S130 of calculating optimal viewing angle information θeff=(θL+θR)/2 by using the angles θL and θR.

In an embodiment of this application, the optimal viewing angle information is θeff=(θL+θR)/2 and may be equal to a formula

$${θ}_{eff} = \frac{1}{n} {\sum }_{k = 0}^{n} {θ}_{k} ,$$

where n may indicate a quantity of viewers.

Next, the method includes a procedure S140 of obtaining an optimal curvature by using the optimal viewing angle information θeff, to control a display surface bending distance of the curved display. In an embodiment of this application, for example, Table 1 may be searched, and Table 1 to be searched may be stored, for example, in the processing unit 40.

TABLE 1

| \|θeff\| | Optimal curvature | Display surface bending distance (mm) |
|---|---|---|
| 0 | 4000R | 50 |
| 1 | 4100R | 49 |
| 2 | 4200R | 48 |
| 3 | 4300R | 47 |
| 90 | Flat surface | 0 |

In an embodiment of this application, according to Table 1, θeff is in a range of 0 degrees to 90 degrees, the optimal curvature is, for example, in a range of 1500R to a flat surface or in a range of 1500R to 5500R, and the display surface bending distance is, for example, in a range of 0 mm to 200 mm or in a range of 30 mm to 100 mm.

According to the curved display apparatus of this application, the curved display apparatus of this application may be, for example, a curved television. The curved display apparatus of this application may include software or a corresponding program, to execute the foregoing control method for adjusting a curvature of a curved display apparatus. The method includes: obtaining scenario picture information by using an image sensor installed on a curved display; calculating a location of a viewer in the scenario picture information by using a processing unit; calculating an angle between the viewer and a central line of the curved display by using the location; and calculating optimal viewing angle information by using the angle, and obtaining an optimal curvature by using the optimal viewing angle information, to control a display surface bending distance of the curved display.

In an embodiment of this application, as shown in FIG. 5, the curved display apparatus may further include a curvature control mechanism 50, electrically connected to the processing unit 40, and configured to bend the curved display 10 according to control information of the processing unit 40, to change a curvature of the curved display 10.

In this application, an image sensor apparatus and a processing unit perform analysis, and a method for intelligently and automatically controlling a display curvature is designed. This application is more flexible than conventional televisions with a fixed curvature, better conforms to an actual application scenario of a viewer, and greatly improves picture quality for a viewer at different viewing angles.

Phrases such as “in some embodiments” and “in various embodiments” are repeatedly used. The phrases generally do not indicate same embodiments, but may also indicate same embodiments. Unless otherwise described in context, terms such as “include”, “have”, and “comprise” are synonyms.

Only preferred embodiments of the present invention are provided above, and are not intended to limit this application in any form. Although preferred embodiments of this application are disclosed above, the preferred embodiments of this application are not intended to limit this application. Any person skilled in the art may change or embellish the technical content disclosed above to obtain equivalent embodiments without departing from the scope of the technical solutions of this application. Therefore, any simple modification, equivalent change, and embellishment made on the foregoing embodiments according to the technical essence of this application without departing from the content of the technical solutions of the present invention shall fall within the scope of the technical solutions of this application.

What is claimed is:

1. A curved display apparatus, comprising:
a curved display, allowing to be bent by a display surface bending distance according to an optimal curvature;
an image sensor, disposed on the curved display to obtain scenario picture information; and
a processing unit, configured to: calculate a location of a viewer in the scenario picture information, and calculate an angle between the viewer and a central line of the curved display by using the location, wherein the optimal curvature is calculated by using the angle.

2. The curved display apparatus according to claim 1, wherein the scenario picture information is used by the image sensor to obtain spatial information of the viewer.

3. The curved display apparatus according to claim 1, wherein there is a plurality of image sensors.

4. The curved display apparatus according to claim 1, wherein the image sensor comprises a pantoscopic lens.

5. The curved display apparatus according to claim 1, wherein the processing unit comprises a facial recognition system, configured to recognize a quantity of viewers in the scenario picture information.

6. The curved display apparatus according to claim 1, wherein the location is a distance between the viewer and a central line of the curved display, and a linear distance between the viewer and the curved display.

7. The curved display apparatus according to claim 6, wherein if the viewer is located on the left of the central line of the curved display, the distance between the viewer and the central line is X1, and the linear distance between the viewer and the curved display is D, the angle θL is arctan (−X1/D); or if the viewer is located on the right of the central line of the curved display, the distance between the viewer and the central line is X2, and the linear distance between the viewer and the curved display is D, the angle θR is arctan (X2/D), wherein the optimal viewing angle information is θeff=(θL+θR)/2.

8. The curved display apparatus according to claim 7, wherein the optimal viewing angle information is θeff=(θL+θR)/2 and may be equal to a formula
$${θ}_{eff} = \frac{1}{n} {\sum }_{k = 0}^{n} {θ}_{k} ,$$
wherein n is a quantity of viewers.

9. The curved display apparatus according to claim 8, wherein θeff is in a range of 0 degrees to 90 degrees, the optimal curvature is in a range of 4000R to a flat surface, and the display surface bending distance is in a range of 50 mm to 0 mm.

10. A curved display apparatus, comprising:
a curved display, allowing to be bent by a display surface bending distance according to an optimal curvature;
an image sensor, disposed on the curved display to obtain scenario picture information; and
a processing unit, configured to calculate a location of a viewer in the scenario picture information, and calculate an angle between the viewer and a central line of the curved display by using the location, wherein the optimal curvature is calculated by using the angle, wherein
the location is a distance between the viewer and a central line of the curved display, and a linear distance between the viewer and the curved display; and if the viewer is located on the left of the central line of the curved display, the distance between the viewer and the central line is X1, and the linear distance between the viewer and the curved display is D, the angle θL is arctan (−X1/D); or if the viewer is located on the right of the central line of the curved display, the distance between the viewer and the central line is X2, and the linear distance between the viewer and the curved display is D, the angle θR is arctan (X2/D), wherein the optimal viewing angle information is θeff=(θL+θR)/2; and
the optimal viewing angle information is θeff=(θL+θR)/2 and may be equal to a formula
$${θ}_{eff} = \frac{1}{n} {\sum }_{k = 0}^{n} {θ}_{k} ,$$
wherein n is a quantity of viewers.

11. The curved display apparatus according to claim 10, wherein the scenario picture information is used by the image sensor to obtain spatial information of the viewer.

12. The curved display apparatus according to claim 10, wherein there is a plurality of image sensors.

13. The curved display apparatus according to claim 10, wherein the image sensor comprises a pantoscopic lens.

14. The curved display apparatus according to claim 10, wherein the processing unit comprises a facial recognition system, configured to recognize a quantity of viewers in the scenario picture information.

15. The curved display apparatus according to claim 10, wherein θeff is in a range of 0 degrees to 90 degrees, the optimal curvature is in a range of 4000R to a flat surface, and the display surface bending distance is in a range of 50 mm to 0 mm.
